(19) United States
(12) Patent Application Publication
(10) Pub. No.: US 2011/0220829 A1
(43) Pub. Date: Sep. 15, 2011

(54) PRESSURE RELIEF VALVE

(75) Inventors: Kai Haemel, Jossgrund (DE); Klaus Schlepp, Maxhuette-Birkenhoehe (DE)

(73) Assignee: MASCHINENFABRIK REINHAUSEN GMBH, Regensburg (DE)

(21) Appl. No.: 13/002,847

(22) PCT Filed: Sep. 22, 2009
(86) PCT No.: PCT/EP2009/006820

§ 371 Date: Apr. 8, 2011

(30) Foreign Application Priority Data
Dec. 3, 2008 (DE) 10 2008 060 337.6

(51) Int. Cl. F16K 27/00

(52) U.S. Cl. 251/366

(57) ABSTRACT

A pressure-relief valve has a housing having an annular flange defining a pressure-vent hole centered on an axis and having an axially directed end face and a radially outwardly directed outer surface. A cap can fit axially over the flange in a closed position and has a skirt radially juxtaposed with the outer surface in the closed position. A spring braced axially between the cap and the housing urges the cap into the closed position. A first annularly continuous seal secured to the end face axially bears on and hermetically engages the cap in the closed position. A second annular seal secured to the outer surface has an outer edge elastically engaging the skirt in the closed position and formed with a notch through which fluid trapped between the first and second seals in the closed position can drain.

The invention relates to a pressure-relief valve for oil-filled transformers and tap changers. If due to faulty functioning or disturbances of the pressure in the oil tank of the transformer or in the tap changer a predetermined limit value is exceeded then the pressure-relief valve, which is closed during normal operation, opens and produces a pressure relief with the ambient atmosphere of the transformer or the tap changer.

Such a pressure-relief valve is known from WO 2004/083700 A1 [US 20060260694]. It has a housing flange, which has a continuous opening and is screw-connected on a transformer cover or the like. The opening of the housing flange is closed at the top by a valve cover. In order to ensure oil-tight sealing by the valve cover, an encircling seal is provided. Moreover, a spring is cover is provided, wherein springs are arranged to be biased between the spring cover and the valve cover. In the case of excess pressure in the transformer tank the valve cover is deflected upwardly against the force of the springs; in this deflected setting it then no longer rests on the encircling seal. The excess hot fluid or also gases thus passes or pass initially into the interior of the pressure-relief valve and outwardly through the outlet opening thereof. As soon as the impermissible excess pressure has dropped again, the valve cover is urged by the spring forces of the valve cover back into its rest position in which it again seals the encircling seal against the opening of the housing flange.

A further seal constructed as a sealing flap is additionally provided in this known pressure-relief valve. This sealing lip is flexibly deflectable in the manner of a windscreen wiper blade and co-operates with the inner side of the downwardly bent, pot-shaped edge region of the valve cover. This additional sealing lip serves the purpose, under specific operating conditions, of increasing the opening speed of the pressure-relief valve when triggered and of avoiding ‘fluttering’.

A quite similar encircling sealing lip, which similarly bears against the valve cover, is also known from U.S. Pat. No. 4,676,266. Its function is there termed “windshield wiper action” and there as well it is to serve the purpose of initially maintaining a specific pressure when the valve cover is opened and thus increasing the speed of opening of the pressure-relief valve when triggered.

Finally, WO 02/057671 [U.S. Pat. No. 6,497,248] describes yet another pressure-relief valve in which the actual functionally necessary sealing of the valve cover and the additionally described sealing lip are combined into a single, integrally formed staircase-shaped seal.

However, it has proved with all these known pressure-relief valves that difficulties can arise in practical operation. After triggering of the pressure-relief valve and return of the valve cover to the rest position a rotationally symmetrical cavity arises, which is formed by the encircling seal with respect to the actual sealing of the valve cover and the further lip seal, which seals the lateral edge region of the valve cover. A defined volume of oil remains in this cavity. Due to the sealing effect, which is indeed desired, of the lip seal according to the prior art this oil volume cannot escape downwardly.

This residual oil volume hinders the response behavior of the pressure-relief valve in the case of further triggering actions, particularly in the case of repeated triggering actions taking place in quick succession. It can have the consequence that the pressure-relief valve in the future responds even in the case of a small pressure rise, which represents faulty triggering. It is additionally possible that, notwithstanding the constructional precautions, undesired ‘fluttering’ nevertheless arises.

A further pressure-relief valve is already known from U.S. Pat. No. 3,217,082 A in which the lower, encircling seal, which corresponds with the valve cover, is constructed as an O-ring seal. The guide of this encircling O-ring seal has recesses in the housing, so that the seal is not pressed in these regions firmly against the inner edge of the valve cover in such a manner that pressure equalization of the cavity between the encircling seals with the environment can take place. However, such a solution is not generally suitable for the pressure-relief valves of the kind with an encircling sealing lip.

It is the object of the invention to eliminate these disadvantages of the known pressure-relief valves and to indicate a pressure-relief valve according to category with an encircling lip seal which retains a constant and reproducible response behavior even in the case of multiple triggering in quick succession. Moreover, no ‘fluttering’ shall occur even in these operating conditions.

This object is fulfilled by a pressure-relief valve with the features of the first patent claim. The subclaims relate to advantageous developments of the invention.

The core of the invention consists in that the encircling sealing lip, which is known per se and which flexibly bears against the downwardly bent pot-shaped edge region of the valve cover, is provided with at least one passage, even better with several passages. It is thereby possible in simple manner for oil, which remains in the space between the actual seal sealing the valve cover and the additional sealing lip, to be able to drip down in stationary operation and thus the response threshold of the pressure-relief valve as a whole remains unchanged.

It is particularly advantageous if the passages according to the invention are provided as recesses at the outer, sealing profile of the sealing lip 19. However, it is equally possible to instead provide holes in the sealing material at another location. The number of recesses can be kept relatively small, so that oil remaining in the described cavity can indeed drip down, but the actual ‘windshield wiper’ function of the sealing lip is not significantly impaired.

The invention shall be explained in more detail in the following by way of drawings, in which:

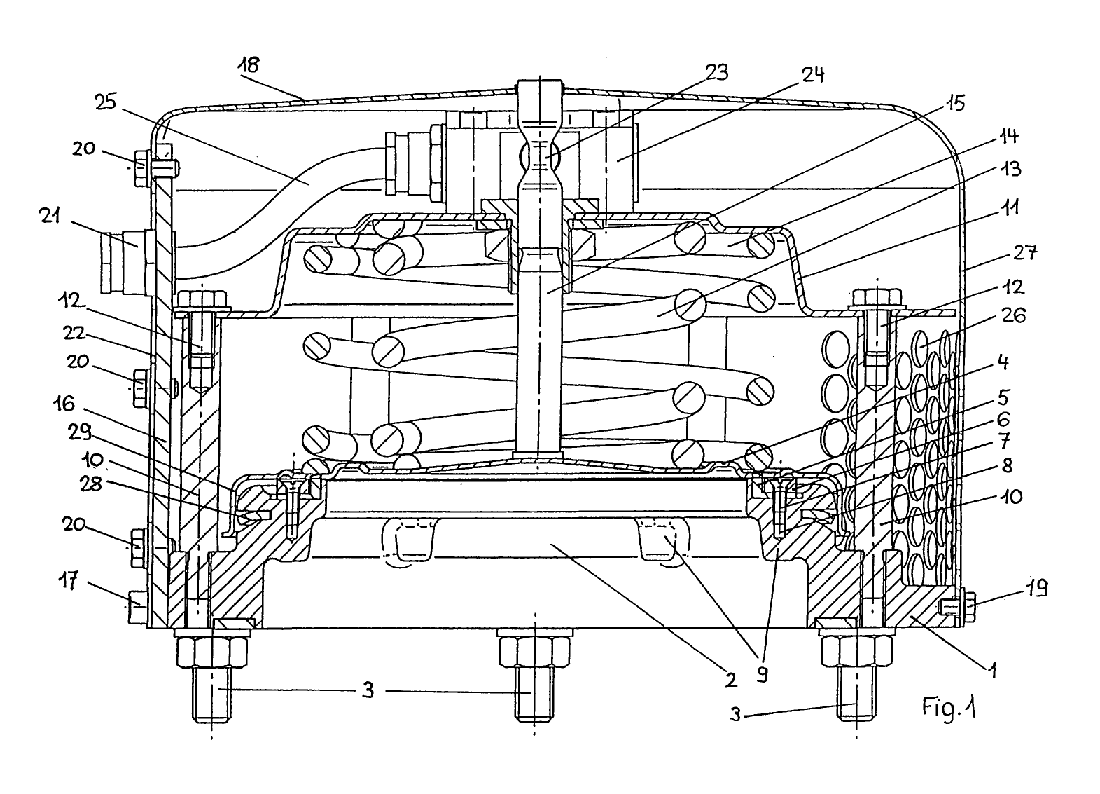

FIG. 1 shows a pressure-relief valve according to the invention in entirely schematic illustration,

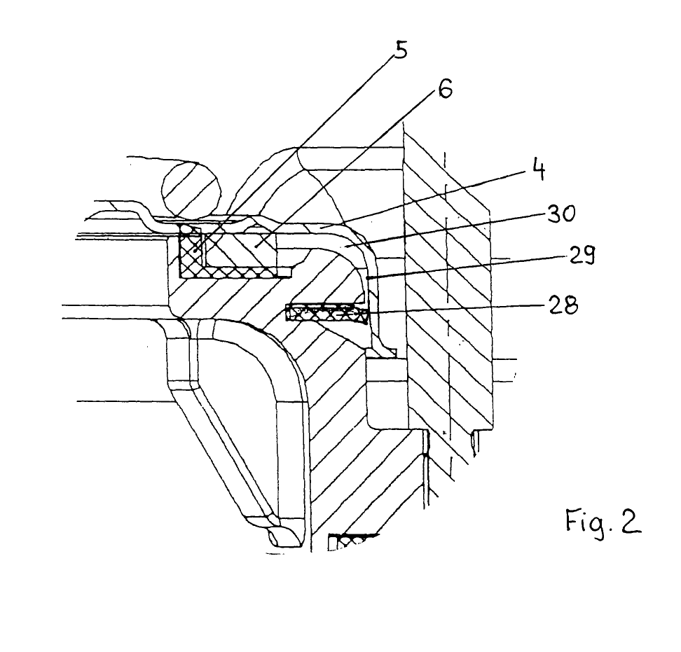

FIG. 2 shows an enlarged detail of FIG. 1 and

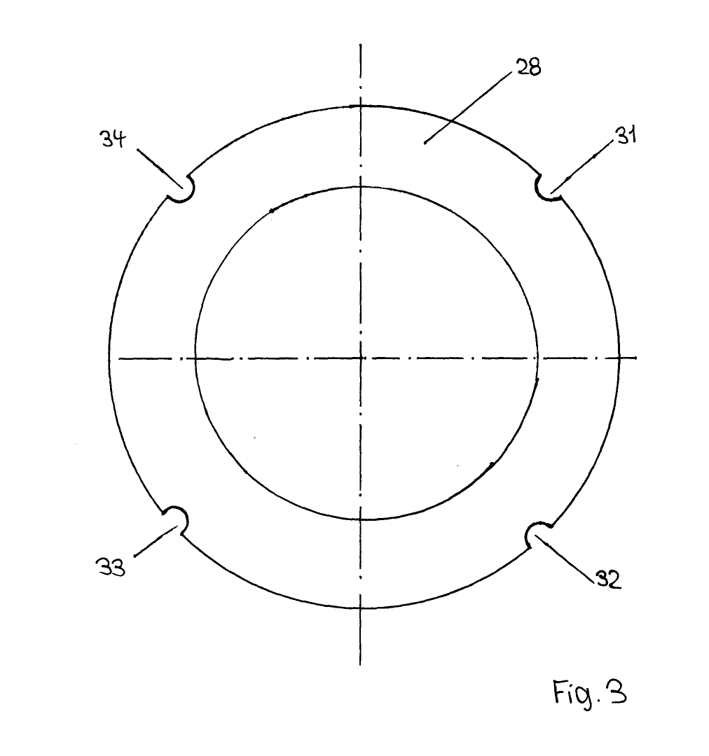

FIG. 3 shows a sealing lip according to the invention by itself and as seen from above.

The basic construction of the pressure-relief valve shall initially be described with reference to FIG. 1.

It comprises a housing flange 1 which is preferably made of cast iron and has a continuous opening 2. This housing flange 1 is screw-connected in a manner known per se by fastening screws 3, which are preferably arranged in circular pattern, with the transformer cover (not illustrated). At the top the opening 2 of the housing flange 1 is closed by a valve cover 4 in known manner. In order to ensure oil-tight sealing, an encircling seal 5 with an L-shaped cross-section is provided, which is fastened by means of a clamping ring 6 and circularly arranged screws 7 to the housing flange 1. Provided for this purpose at reinforcing ribs 9 of the housing flange 1 are threads 8 into which the screws 7 are screwed so that the clamping ring 6 reliably fixes the seal 5. Moreover, is screwed into the housing flange 1 are bolts 10, which extend perpendicularly upwardly, with an internal thread. A spring cover 11, which corresponds with the housing cover according to the prior art, is fastened to the bolts 10 by means of screws 12, which are screwed from above into the internal threads of the bolts. Two biased springs, namely an inner spring 13 and an outer spring 14, are disposed between spring cover 11 and valve cover 4 in a manner known per se. Both the inner spring 13 and the outer spring 14 are supported by the respective upper ends thereof against concentric projections at the underside of the spring cover 11; they are supported by the respective upper ends thereof on the upper side of the valve cover 4, which similarly has a corresponding concentric contouring. In addition, a signal pin 15, which extends perpendicularly upwards, is provided centrally at the valve cover 4. In addition, a vertical passage plate 16, which is discussed later in more detail, is fastened laterally to the housing flange 1 by means of fastening screws 17. The entire apparatus is enclosed by a pot-shaped housing 18 which is fastened by means of screws 19 to the housing flange 1 as well as by means of further screws 20 to the passage plate 16. One or more cable passages 21 are provided at the passage plate 16; in order that the housing 18 can be mounted, it has a lateral cut-out 22 in such a manner that it can be pushed by this cut-out 22 from above over the cable passages 22 during assembly. The signal pin 15 has in its upper region in the interior of the apparatus a switching profile 23 by which one or more switches 24, for example roller switches or limit switches, can be actuated. Cables 25 run from these switches 24 through the cable guide 21 to the outside. Outlet openings 26, which are arranged in the pot-shaped side region 27 which extends perpendicularly downwardly, are provided on the side of the housing 18 opposite the cable passages 21.

In addition, the sealing lip 28 is shown, which is loosely inserted and which is deflectable in the manner of a windscreen wiper blade. This sealing lip 28 co-operates with the downwardly bent pot-shaped edge region 29 of the valve cover 4. It serves, as already described further above, for the purpose of increasing the speed of opening of the pressure-relief valve as well as avoiding ‘fluttering’.

FIG. 2 shows an enlarged detail of the pressure-relief valve; illustrated here once more are a part of the valve cover 4, the encircling seal 5 which is fastened by a clamping ring 6, and the sealing lip 28. It can be more clearly seen in this illustration that this sealing lip 28 seals the downwardly bent inner edge region 29 of the valve cover 4. On triggering of the pressure-relief valve the upper seal 5 initially lifts off the valve cover 4, whilst the additional, rotationally symmetrical sealing lip 28 still maintains the sealing function at the similarly rotationally symmetrically encircling edge region 29. This has the consequence that the opening speed is increased by the increased pressure, i.e. the valve cover 4 is moved upwardly with greater force against the force of the springs (not illustrated here). It can be seen in FIG. 2 that a rotationally symmetrical cavity 30 remains between the seal 5 and the sealing lip 28. Since the sealing lip 28 in stationary operation bears in sealing manner against the edge region 29, oil, which is disposed in this cavity 30 and which remains there after the last opening of the pressure-relief valve cannot run down and does not disadvantageously influence the further response behavior.

A sealing lip 28 according to the invention, which has several recesses 31, 32, 33 and 34, is shown in FIG. 3. These recesses interrupt the encircling seal and make it possible for the residual oil to drip downwardly out of the cavity 30.

In the illustrated exemplifying embodiment these recesses 31 to 34 are formed to be circular; however, all other geometric forms of such recesses are obviously also possible within the scope of the invention. Moreover, it is also possible within the scope of the invention to provide such openings not as recesses at the sealing edge of the sealing lip 28, but as passages further into the center of the seal.

In addition, the number of recesses is freely selectable within wide limits within the scope of the invention, wherein it has proved that several small recesses distributed at different points of the circumference have a better effect than a single large recess.

It is particularly advantageous to so dimension the recesses 31 to 34, if they are formed at the outer sealing edge as shown in FIG. 3, that not more than 1 to 5% of the encircling seal has no sealing action. Through this dimensioning it is ensured that the recesses on the one hand are large enough to allow oil remaining in the cavity to drip down and on the other hand small enough to not significantly influence the sealing ‘windshield wiper’ function of the sealing lip 28 for increasing the opening speed.

The object of the invention can be fulfilled by this relatively simple measure; such a sealing lip according to the invention can also be subsequently installed in already existing pressure-relief valves.

Apart from the described advantage of the invention of giving a constant, reproducible response behavior even in the case of multiple triggering in quick succession, still further advantages arise:

It is now possible through the sealing lip according to the invention to carry out a check of the tightness of the pressure-relief valve after the functional check. According to the prior art, sealing checks with oil or helium were previously possible only before the functional check at a subassembly or only with subsequent demounting of components of the pressure-relief valve, since the check medium could collect, in unmeasurable or unrecognizable manner, between seal and sealing lip in the event of leakage. In the pressure-relief valve according to the invention, by contrast, such a sealing check can be undertaken after the actual functional check, i.e. the checking of the trigger pressure. It is thus ensured that the pressure-relief valve can be supplied, reliably sealed, in correspondence with the respective requirements. In the case of the prior art it was uncertain with such checks whether the pressure-relief valve had closed tightly again after a functional check had been undertaken. Slight tilting after the functional check could lead to leakages, which would be is discovered only later after installation. However, at this point in time exchange of a pressure-relief valve is very time-consuming, since the coolant of the transformer or tap changer usually has to first be released.

1. A pressure-relief valve for oil-filled transformers and tap changers, which comprises a housing flange having an opening disposed in connection with the volume of the transformer or tap changer, wherein the housing flange is closed in the stationary state by a valve cover on which the force of springs acts in closing direction, wherein an encircling seal is provided between the opening of the housing flange and the valve cover and wherein an additional, stationary encircling sealing lip co-operating with the inner, downwardly bent, pot-shaped edge region of the valve cover is provided, wherein the sealing lip has at least one opening by which complete sealing is interrupted.

2. The pressure-relief valve according to claim 1, wherein the at least one opening is formed as at least one recess which interrupts the sealing edge of the sealing lip.

3. The pressure-relief valve according to claim 2, wherein at most 5% of the encircling sealing edge of the sealing lip is interrupted by the at least one recess.

4. A pressure-relief valve comprising:
a housing having an annular flange defining a central pressure-vent hole centered on an axis and having an axially directed end face and a radially outwardly directed outer surface;
a cap fittable axially over the flange in a closed position and having a skirt radially juxtaposed with the outer surface in the closed position;
a spring braced axially between the cap and the housing and urging the cap into the closed position, whereby a pressurized in the hole underneath the cap can, when exceeding a predetermined limit, lift the cap off the end face and pass between the cap and the flange over the seals;
a first annularly continuous seal secured to the end face and axially bearing on and hermetically engaging the cap in the closed position; and
a second annular seal secured to the outer surface and having an outer edge elastically engaging the skirt in the closed position, the second seal being formed with at least one vent opening through which fluid trapped between the first and second seals in the closed position can drain.

5. The pressure-relief valve defined in claim 4 wherein the cap is downwardly cup-shaped and defines in the closed position an annular chamber with the flange between the seals.

6. The pressure-relief valve defined in claim 5 wherein the second seal is a flat blade projecting radially from the flange outer face and functioning like a windshield wiper on a cylindrical inner surface of the skirt.

7. The pressure-relief valve defined in claim 4 wherein the opening is a radially outwardly open notch formed in an outer periphery of the second seal.

8. The pressure-relief valve defined in claim 7 wherein the opening is formed by a plurality of the notches distributed angularly around the second seal.

9. The pressure-relief valve defined in claim 8 wherein the notches interrupt at most 5% of the outer periphery of the second seal.
